(19) United States
(12) Patent Application Publication
(10) Pub. No.: US 2019/0292366 A1
(43) Pub. Date: Sep. 26, 2019

(54) POLYAMIDE COMPOSITIONS

(71) Applicant: LANXESS Deutschland GmbH, Cologne (DE)

(72) Inventors: Matthias BIENMUELLER, Krefeld (DE); Jochen ENDTNER, Cologne (DE)

(73) Assignee: LANXESS Deutschland GmbH, Cologne (DE)

(21) Appl. No.: 16/360,512

(22) Filed: Mar. 21, 2019

(30) Foreign Application Priority Data
Mar. 26, 2018 (EP) 18163857.8

(51) Int. Cl. C08L 77/02; C08G 69/14; C08G 69/26; C08J 5/04; C08K 3/32; C08K 5/5313; C08K 5/13; C08K 5/20; C08K 13/02; H01M 2/10; H01M 10/625; H01M 10/613; H01M 10/42

(52) U.S. Cl. CPC C08L 77/02; B29C 45/0001; C08G 69/26; C08J 5/042; C08K 3/32; C08K 5/5313; C08K 5/13; C08K 5/20; C08K 13/02; H01M 2/1072; H01M 10/625; H01M 10/613; H01M 10/425; C08J 2377/02; C08J 2377/06; C08J 2477/10; C08J 2467/02; C08L 2205/025; C08L 2201/08; C08L 2203/20; C08K 2003/327; H01M 2010/4271; H01M 2220/20; C08G 69/14

(57) ABSTRACT

A flame-retardant polyamide with improved flexural strength and a low propensity for surface changes is based on polyamide 6 and/or polyamide 66, carbon fibres, at least one aluminium salt of phosphonic acid, and one or more organic phosphinic acid salts and/or one or more diphosphinic acid salts.

The present invention relates to compositions based on fibre containing polyamide, such as polyamide 6 and/or polyamide 66 containing carbon fibres, at least one aluminium salt of phosphonic acid and one or more organic phosphinic acid salts and/or one or more diphosphinic acid salts.

### BACKGROUND INFORMATION

Polyamides are an important thermoplastic material due to their good mechanical stability, their chemicals resistance and good workability, especially in the field of components for motor vehicles. Thus glass fibre-reinforced polyamides have been important constituents in demanding motor vehicle applications for many years. While the internal combustion engine has been the dominant drive concept for many years, new requirements with regard to the choice of materials arise in the course of the search for alternative drive concepts. Playing a substantial role here is electromobility where the internal combustion engine is replaced partially (hybrid vehicle) or completely (electric vehicle) by one or more electrical motors which typically obtain their electrical energy from batteries. Depending on the range to be achieved with one battery charge, the battery systems make up a significant proportion of the total weight of the vehicle. Thus, according to https://de.wikipedia.org/wiki/Elektroauto for a range of around 150 km small electric cars already require accumulators having a mass of about 200 kg. This requires on the one hand new technology and material concepts for secure mounting of such masses in vehicles but on the other hand also a stronger focus on materials with lower density in order thus to be able to at least partially compensate the additional mass of the battery and altogether reduce the energy consumption of the vehicle. Due to the high electrical voltages and currents in battery systems and/or in the electric powertrain there are also additional risks—especially in the case of a fault—of rapidly rising temperatures, sparks or electric arcs which place additional yet higher demands on the fire safety of such vehicle components. This has the overall result that the glass fibre-reinforced polyamides established in cars with internal combustion engines and mentioned at the outset reach their limits taking into account the additional requirements of very high stiffness coupled with very high strength and low density and high flame retardancy.

This applies all the more if the further requirements typical in the automotive industry are included, in particular resistance to changing temperatures and hot and humid climates.

The use of carbon fibres in polyamide 6 (PA6) and polyamide 66 (PA 66) is known from the literature. (Becker, G., Braun, D. (ed.) (1998:) Plastics Handbook, 3. Engineering Thermoplastics; 4. Polyamides, Munich; Vienna: Hanser, revised edition p. 106). However, those skilled in the art will find no instruction therein as to technical means for solving the specific requirements of increased flame retardancy. However, since unlike mineral fibres or glass fibres for instance carbon fibres contribute an additional amount of heat during combustion due to their carbon content, the literature reciting a calorific value of carbon of 32.8 MJ/kg (https://de.wikipedia.org/wiki/Heizwert), the flame retardancy of carbon fibre-reinforced PA 6 and PA 66 articles of manufacture for use in motor vehicle manufacture is of significant importance.

To improve flame retardancy polyamides are often modified with flame retardants. In recent times halogenated flame retardants suitable for use therefor have for technical reasons on account of concerns among the public increasingly been replaced by halogen-free alternatives, for example those based on organic phosphorus compounds such as for example organically substituted metal phosphinates according to EP 0 792 912 A2 or mixtures of flame retardants with aluminium phosphites according to WO 2013/083247 A1. The organically substituted metal phosphinates are commonly used in combination with flame retardant synergists, for example based on nitrogen-containing flame retardant, or with other auxiliaries, such as for example metal borates, in particular zinc borates according to WO 2006/029711 A1, or in combination with melamine condensation products or with melamine-phosphoric acid products according to US 2007/173573 A1.

EP 3 034 553 A1 teaches heat-stabilized polyamide compositions containing reinforcers, including inter alia carbon fibres, organically substituted metal phosphinates, at least one aluminium salt of phosphonic acid and at least one polyhydric alcohol, for example dipentaerythritol, wherein zinc borates may ideally be avoided, without however elaborating on possible more specific problems in conferring flame retardancy on carbon fibre-reinforced polyamides. EP 3 034 553 A1 too provides no indications of the behaviour and stability of the compositions described therein at varying temperatures and in a hot and humid climate.

The problem addressed by the present invention, specifically with a view to applications and articles of manufacture for electromobility, especially in the field of battery systems, was accordingly that of providing halogen-free flame retarded polyamide compositions having a very high flexural strength which exhibit a high stability and a low propensity for surface changes even in a hot and humid climate and thus ideally do not require the use of zinc borates.

### SUMMARY OF THE INVENTION

It has now been found that, surprisingly, compositions and articles of manufacture producible therefrom based on fiber-containing polyamide, for example, carbon fibre-containing PA 6 or PA 66, and at least one aluminium salt of phosphonic acid and also at least one organic metal phosphinate exhibit significantly improved flexural strength and a low propensity for surface changes in a hot and humid climate without impairing flame retardancy in the UL94 test and without requiring the use of zinc borate.

Used here as a measure of surface changes in a hot and humid climate is the discolouration of an originally black surface after 14 days of storage at 85° C. and 85% relative humidity, wherein the discolouration is assessed according to the grey scale according to ISO 105-A02; see: https://www.carl-von-gehlen.de/graumassstaebe.html.

### DESCRIPTION OF THE EMBODIMENTS

The present invention provides compositions containing
A) polyamide having a viscosity number determinable according to ISO 307 with a 0.5% by weight solution in 96% by weight sulfuric acid at 25° C. in the range from 80 to 180 ml/g,
B) fibre reinforcement,
C) at least one aluminium salt of phosphonic acid, and
D) one or more organic phosphinic acid salts of formula (I) and/or one or more diphosphinic acid salts of formula (II) and/or polymers thereof,

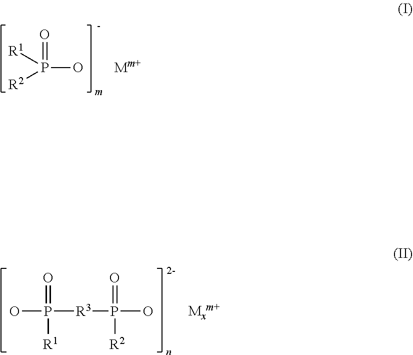

in which
R¹, R² are identical or different and stand for a linear or branched C₁-C₆-alkyl and/or for C₆-C₁₄-aryl,
R³ stands for linear or branched C₁-C₁₀-alkylene, C₆-C₁₀-arylene or for C₁-C₆-alkyl-C₆-C₁₀-arylene or C₆-C₁₀-aryl-C₁-C₆-alkylene,
M stands for aluminium, zinc or titanium,
m stands for an integer from 1 to 4;
n stands for an integer from 1 to 3 and
x stands for 1 and 2,
wherein n, x and m in formula (II) may at the same time adopt only integer values such that the diphosphinic acid salt of formula (II) as a whole is uncharged.

In an embodiment, the polyamide is polyamide 6 and/or polyamide 66, and the fibre is carbon fibre.

However, the invention also relates to articles of manufacture, preferably battery system components, based on compositions containing
A) polyamide 6 and/or polyamide 66 in each case having a viscosity number determinable according to ISO 307 with a 0.5% by weight solution in 96% by weight sulfuric acid at 25° C. in the range from 80 to 180 ml/g,
B) carbon fibres,
C) at least one aluminium salt of phosphonic acid, and
D) one or more organic phosphinic acid salts of formula (I) and/or one or more diphosphinic acid salts of formula (II) and/or polymers thereof,

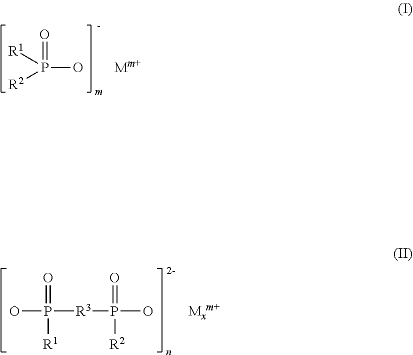

in which
R¹, R² are identical or different and stand for a linear or branched C₁-C₆-alkyl and/or for C₆-C₁₄-aryl,
R³ stands for linear or branched C₁-C₁₀-alkylene, C₆-C₁₀-arylene or for C₁-C₆-alkyl-C₆-C₁₀-arylene or C₆-C₁₀-aryl-C₁-C₆-alkylene,
M stands for aluminium, zinc or titanium,
m stands for an integer from 1 to 4;
n stands for an integer from 1 to 3 and
x stands for 1 and 2,
wherein n, x and m in formula (II) may at the same time adopt only integer values such that the diphosphinic acid salt of formula (II) as a whole is uncharged.

Preferred articles of manufacture are those for use in the electric powertrain and/or battery system of vehicles with electric drive (hybrid or electric vehicles), particularly preferably in the field of battery systems. Especially preferred battery system components in the context of the present invention are holders, securing means and mountings of a battery system or individual components of a battery system, preferably cell modules, cooling apparatuses or battery management systems.

For clarity, it should be noted that the scope of the present invention encompasses all the definitions and parameters mentioned hereinafter in general terms or specified within areas of preference, in any desired combinations. Cited standards are considered to mean the version in force at the filing date of this application

Preparation of the compositions according to the invention for further use is carried out by mixing the components A) to D) to be used as reactants in at least one mixing apparatus. This affords, as intermediates, moulding materials based on the compositions according to the invention. These moulding materials may either consist exclusively of the components A) to D) or else contain further components in addition to the components A) to D).

Reference is made to C. Jaroschek, Zeitschrift Kunststofftechnik 8 (2012) 5, 516-524 for measurement of flexural strength which in the context of the present invention is determined according to ISO 178-A on freshly injection moulded test specimens having dimensions of 80 mm·10 mm·4 mm, wherein in the context of the present invention the flexural modulus is used as a measure for flexural strength.

In the context of the present invention, especially in the formulas (I) and (II), “alkyl” is to be understood as meaning a straight-chain or branched saturated hydrocarbon group. If for example an alkyl group or polyalkylene group having 1 to 4 carbon atoms is used, this can be referred to as a “lower alkyl group” and can preferably comprise methyl (Me), ethyl (Et), propyl, in particular n-propyl and isopropyl, butyl or in particular n-butyl, isobutyl, sec-butyl or tert-butyl.

An aryl group, abbreviated Ar or aryl, is an organic chemical radical having an aromatic backbone. Aryl is the general term for a single atom group deriving from aromatic hydrocarbons by removal of a hydrogen atom bonded to the ring. Aryl radicals preferred according to the invention derive from benzene (C₆H₆). Particularly preferred aryl radicals are phenyl, 1-naphthyl, 2-naphthyl, 9-anthryl and 9-phenanthryl. Very particular preference is given to phenyl (Ph) or (—C₆H₅).

The standards recited in the context of this application relate to the edition current on the application date of the present invention.

In an embodiment, the invention relates to compositions/articles of manufacture based on compositions containing
A) per 100 parts by mass of polyamide 6 and/or polyamide 66 in each case having a viscosity number determinable according to ISO 307 with a 0.5% by weight solution in 96% by weight sulfuric acid at 25° C. in the range from 80 to 180 ml/g,
B) 2 to 120 parts by mass, preferably 9 to 90 parts by mass, in particular 12 to 70 parts by mass, of carbon fibres,
C) 3 to 30 parts by mass, preferably 5 to 20 parts by mass, particularly preferably 7 to 15 parts by mass, of at least one aluminium salt of phosphonic acid and
D) 8 to 80 parts by mass, preferably 10 to 55 parts by mass, particularly preferably 8 to 45 parts by mass of one or more organic phosphinic acid salts of formula (I) and/or one or more diphosphinic acid salts of formula (II) and/or polymers thereof,

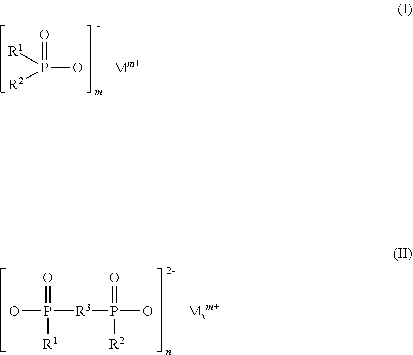

in which
R¹, R² are identical or different and stand for a linear or branched C₁-C₆-alkyl and/or for C₆-C₁₄-aryl,
R³ stands for linear or branched C₁-C₁₀-alkylene, C₆-C₁₀-arylene or for C₁-C₆-alkyl-C₆-C₁₀-arylene or C₆-C₁₀-aryl-C₁-C₆-alkylene,
M stands for aluminium, zinc or titanium,
m stands for an integer from 1 to 4;
n stands for an integer from 1 to 3 and
x stands for 1 and 2,
   wherein n, x and m in formula (II) may at the same time adopt only integer values such that the diphosphinic acid salt of formula (II) as a whole is uncharged.

In a preferred embodiment the compositions/articles of manufacture contain in addition to the components A), B), C) and D) also E) at least one heat stabilizer from the group of the sterically hindered phenols, preferably in an amount of 0.02 to 4 parts by mass, particularly preferably 0.1 to 2 parts by mass, very particularly preferably 0.2 to 1.5 parts by mass, in each case based on 100 parts by mass of the component A).

In a further preferred embodiment the compositions contain in addition to the components A) to E) or instead of E) also F) glass fibres, preferably in an amount of 10 to 150 parts by mass, particularly preferably 15 to 80 parts by mass, very particularly preferably 20 to 50 parts by mass, in each case based on 100 parts by mass of component A).

In a further preferred embodiment the compositions contain in addition to the components A) to F) or instead of E) and/or F) also G) at least one filler or reinforcer distinct from the components B) and F), preferably in an amount of 1 to 150 parts by mass, particularly preferably 5 to 80 parts by mass, very particularly preferably 10 to 50 parts by mass, in each case based on 100 parts by mass of component A).

In a further preferred embodiment the compositions contain in addition to the components A) to G) or instead of E) and/or F) and/or G) also H) at least one further additive distinct from the components B) to G), preferably in an amount of 0.01 to 80 parts by mass, particularly preferably 0.05 to 50 parts by mass, very particularly preferably 0.1 to 30 parts by mass, in each case based on 100 parts by mass of component A).

### Component A)

As component A) the compositions contain PA 6 [CAS No. 25038-54-4] and/or PA 66 [CAS No. 32131-17-2], in each case having a viscosity number determinable according to ISO 307 with a 0.5% by weight solution in 96% by weight sulfuric acid at 25° C. in the range from 80 to 180 ml/g. Copolyamides based on PA 6 and/or PA 66 are comprised in the subject matter of the present invention.

The nomenclature of the polyamides used in the context of the present application corresponds to the international standard, the first number(s) denoting the number of carbon atoms in the starting diamine and the last number(s) denoting the number of carbon atoms in the dicarboxylic acid. If only one number is stated, as in the case of PA6, this means that the starting material was an α,ω-aminocarboxylic acid or the lactam derived therefrom, i.e. ε-caprolactam in the case of PA 6; for further information, reference is made to H. Domininghaus, Die Kunststoffe und ihre Eigenschaften, pages 272 ff., VDI-Verlag, 1976.

The polyamide 6 for use as component A) preferably has a viscosity number determinable according to ISO 307 in a 0.5% by weight solution in 96% by weight sulfuric acid at 25° C. in the range from 85 to 160 ml/g, particularly preferably in the range from 90 to 140 ml/g, especially preferably in the range from 95 to 115 ml/g.

The polyamide 66 for alternative use as component A) preferably has a viscosity number determinable according to ISO 307 in a 0.5% by weight solution in 96% by weight sulfuric acid at 25° C. in the range from 90 to 170 ml/g, particularly preferably in the range from 95 to 160 ml/g and especially preferably in the range from 100 to 135 ml/g.

Viscosity measurements in solution are used to determine the K value, a molecular parameter by which the flow properties of plastics can be characterized. In simplified form: [η]=2.303×(75 k²+k) where K value=1000 k and [η]=Staudinger viscosity. The viscosity number VN in millilitres per gram is determinable therefrom according to IS0307 without complicated conversion calculations.

$$VN = ( \frac{η}{{η}_{0}} - 1 ) \frac{1}{c}$$

See: http://www.mhaeberl.de/KUT/3Kunststoffschmelze.htm. In practice, tables for converting the K value into the viscosity number VN exist.

According to Hans Domininghaus in “Die Kunststoffe und ihre Eigenschaften”, 5th edition (1998), p. 14, the term thermoplastic polyamides is to be understood as meaning polyamides whose molecular chains have no side branches or else have side branches which are of greater or lesser length and differ in number and which soften when heated and are virtually infinitely mouldable. The polyamides PA 6 and PA 66 for use as component A) are semicrystalline polyamides. According to DE 10 2011 084 519 A1 semicrystalline polyamides have an enthalpy of fusion in the range from 4 to 25 J/g measured by the DSC method according to ISO 11357 upon 2nd heating and integration of the melt peak. By contrast, amorphous polyamides have an enthalpy of fusion of less than 4 J/g measured by the DSC method according to ISO 11357 upon 2nd heating and integration of the melt peak.

The polyamides PA6 and PA66 for use as component A) may be employed alone or in combination with processing aids, stabilizers or else polymeric alloy partners, preferably elastomers, to afford materials having specific combinations of properties. Also suitable are blends comprising proportions of other polymers, preferably of polyethylene, polypropylene, acrylonitrile-butadiene-styrene copolymer (ABS), one or more compatibilizers being optionally employable. The properties of the PA6/PA66 can be improved by addition of elastomers, for example in terms of impact resistance. The multitude of possible combinations permits a very large number of products having a very wide variety of different properties.

The polyamide 6 to be employed as component A) is obtainable from ε-caprolactam. The polyamide 66 to be employed as component A) is obtainable from hexamethylenediamine and adipic acid.

Preference is further given to most compounds based on PA 6, PA 66 or copolyamides thereof where there are 3 to 11 methylene groups, particularly preferably 4 to 6 methylene groups, for each polyamide group in the polymer chain.

Polyamide 6 for use according to the invention as component A) is obtainable for example under the name Durethan® B24 from Lanxess Deutschland GmbH, Cologne, and polyamide 66 for use according to the invention as component A) is obtainable under the name Ultramid® A24E01 from BASF SE, Ludwigshafen.

### Component B)

As component B) the compositions contain reinforcement fibres, which may preferably be carbon fibres. Component B) is preferably implemented as follows: A first embodiment is characterized in that the component B) is preferably employed as a chopped fibre or as a chopped or endless fibre bundle.

A further preferred embodiment is characterized in that carbon fibres for use as component B) have an average length in the range from 0.1 to 50 mm, preferably in the range from 2 to 26 mm, particularly preferably in the range from 4 to 8 mm, wherein in the context of the present invention determination of the length is performed using a USB microscope with calibration, in particular a Dino-Lite Edge AM7915MZT digital microscope with Dino Capture 2.0 software; Dino-Lite Europe/IDCP B.V., Naarden, the Netherlands.

In addition or as an alternative carbon fibres preferred for use as component B) according to the invention are characterized by an average diameter determinable with an electron microscope in the range from 5 to 40 μm, particularly preferably in the range from 5 to 10 μm.

All of the above relates to the starting material for component B) immediately before incorporation into a/to afford a moulding material. Incorporation into/to afford a moulding material and/or downstream processing operations, such as injection moulding, can result in shortening of the carbon fibres.

A further preferred embodiment is characterized in that the carbon fibres for use as component B) are produced in a pyrolysis process starting from cellulose-based fibres, pitch or polyacrylonitrile (PAN), wherein those produced from PAN are very particularly preferred according to the invention.

The carbon fibres for use as component B) may be formed from several hundred to several hundred thousand individual filaments preferably having a filament diameter in the range from 5 to 10 μm determinable with an electron microscope. According to https://de.wikipedia.org/wiki/Kohlenstofffaser a distinction is made between multifilament yarns having 1000 to 24 000 individual fibres and HT types (High Tensity) having 120 000 to 400 000 individual fibres.

In a further preferred embodiment the carbon fibres for use as component B) may have been provided on their surface with a size or an adhesion promoter/adhesion promoter system to improve or even just allow their processing and to bring about a good compatibility with the polyamides for use as component A).

In a further preferred embodiment—if required and having accounted for the associated disadvantages of a density increase—the carbon fibres for use as component B) may have been provided with a metallic coating in order thus to achieve an improvement in electrical conductivity in the finished article of manufacture, particularly in the case of elevated electromagnetic shielding requirements. The use of nickel as the metal is particularly preferred here. In this regard see for example EP 2 788 542 B 1 and the literature cited therein.

It is very particularly preferable according to the invention when chopped carbon fibres having a length determinable by means of a USB microscope in the range from 4 to 7 mm are employed which are especially preferably admixed into the moulding material in the form of carbon bundles, preferably via an extruder or by means of an injection moulding machine.

It is particularly preferable when the carbon fibres of the component B) are admixed with the component A) in extruders, wherein introduction into the rear region of the extruder, preferably via a side extruder, is very particularly preferable. “At the rear” refers to the region of the extruder closer to the spinning nozzle while “at the front” is to be understood as the part which is further from the spinning nozzle.

If required the carbon fibres for use as component B) may alternatively be added in the front region, preferably via the main hopper of an extruder, but this typically results in a more severe shortening of the carbon fibres in the moulding material and thus in lower stiffnesses.

In an alternate embodiment the carbon fibres may also be admixed with component A) in the form of a carbon fibre masterbatch to obtain a moulding material according to the invention.

Carbon fibres for use as component B) according to the invention are commercially obtainable for example under the trade name Tenax®-E-HT C604 6 mm or Tenax®-J HT C493 6 mm from Toho Tenax Europe GmbH, the latter being especially preferred.

### Component C)

As component C) the compositions contain at least one aluminium salt of phosphonic acid.

According to Wikipedia phosphonic acid is to be understood as meaning the substance with the empirical formula H₃PO₃ [CAS No. 13598-36-2](http://de.wikipedia.org/wiki/Phosphons % C3% A4ure). The salts of phosphonic acid are called phosphonates. Phosphonic acid may exist in two tautomeric forms, of which one has a free electron pair on the phosphorus atom and the other has oxygen double-bonded to the phosphorus (P═O). The tautomeric equilibrium is very much on the side of the double-bonded oxygen form. According to A. F. Holleman, E. Wiberg: Textbook of inorganic chemistry. 101st Edition. Walter de Gruyter, Berlin/New York 1995, ISBN 3-11-012641-9, p. 764 the terms “phosphorous acid” and “phosphites” should be used only for the tautomeric species having a free electron pair on the phosphorus. The terms “phosphorous acid” and “phosphites” were, however, previously also used for the tautomeric forms having oxygen double-bonded to the phosphorus and accordingly the terms phosphonic acid and phosphorous acid and phosphonates and phosphites are used synonymously in the present invention.

It is preferable when as component C) at least one aluminium salt of phosphonic acid is selected from the group of

primary aluminium phosphonate [Al(H₂PO₃)₃],
basic aluminium phosphonate [Al(OH)H₂PO₃)₂.2H₂O],
Al₂(HPO₃)₃.x Al₂O₃.n H₂O where X is in the range from 2.27 to 1 and n is in the range from 0 to 4,
Al₂(HPO₃)₃.(H₂O)_{q} of formula (III) where q is in the range from 0 to 4, in particular aluminium phosphonate tetrahydrate [Al₂(HPO₃)₃*4H₂O] or secondary aluminium phosphonate [Al₂(HPO₃)₃],
Al₂M_{z}(HPO₃)_{y}(OH)ᵥ.(H₂O)_{w} of formula (IV) in which M represents alkali metal ion(s) and z is in the range from 0.01 to 1.5, y is in the range from 2.63-3.5, v is in the range from 0 to 2 and w is in the range from 0 to 4 and
Al₂(HPO₃)ᵤ(H₂PO₃)ₜ.(H₂O)ₛ of formula (V) where u is in the range from 2 to 2.99, t is in the range from 2 to 0.01 and s is in the range from 0 to 4,
wherein in formula (IV) z, y and v and in formula (V) u and t assume only numbers such that the relevant aluminium salt of phosphonic acid as a whole is uncharged.

Preferred alkali metals in formula (IV) are sodium and potassium.

The described aluminium salts of phosphonic acid may be used individually or in admixture.

Particularly preferred aluminium salts of phosphonic acid are selected from the group

primary aluminium phosphonate [Al(H₂PO₃)₃],
secondary aluminium phosphonate [Al₂(HPO₃)₃],
basic aluminium phosphonate [Al(OH)H₂PO₃)₂.2H₂O],
aluminium phosphonate tetrahydrate [Al₂(HPO₃)₃.4H₂O] and
Al₂(HPO₃)₃.x Al₂O₃.n H₂O where x is in the range from 2.27 to 1 and n is in the range from 0 to 4.

Very particularly preferred are secondary aluminium phosphonate [Al₂(HPO₃)₃], CAS No. 71449-76-8] and secondary aluminium phosphonate tetrahydrate [Al₂(HPO₃)₃[₄H₂O], CAS No. 156024-71-4], secondary aluminium phosphonate being especially preferred [Al₂(HPO₃)₃].

Production of the aluminium salts of phosphonic acid for use as component C) according to the invention is described in WO 2013/083247 A1 for example. Said production is typically performed by reaction of an aluminium source, preferably aluminium isopropoxide, aluminium nitrate, aluminium chloride or aluminium hydroxide, with a phosphorus source, preferably phosphonic acid, ammonium phosphonate, alkali metal phosphonate. A template is optionally used therefor. The reaction is carried out in a solvent at 20° C. to 200° C. over a period of up to 4 days. To this end the aluminium source and the phosphorus source are mixed, heated under hydrothermal conditions or under reflux, filtered, washed and dried.

Preferred templates are 1,6-hexanediamine, guanidine carbonate or ammonia.

Water is preferred as solvent.

### Component D)

As component D) the compositions according to the invention contain one or more organic phosphinic acid salts of the abovementioned formula (I) and/or one or more diphosphinic acid salts of the abovementioned formula (II) and/or polymers thereof. In the context of the present invention phosphinic acid salts and diphosphinic acid salts are also referred to as phosphinates.

In formulae (I) or (II) M preferably stands for aluminium. In formulae (I) and (II) R¹ and R² are preferably identical or different and represent linear or branched C₁-C₆-alkyl and/or phenyl. It is particularly preferable when R¹, R² are identical or different and represent methyl, ethyl, n-propyl, isopropyl, n-butyl, tert-butyl, n-pentyl and/or phenyl.

R³ in formula (II) preferably represents methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene or phenylbutylene. R³ particularly preferably represents phenylene or naphthylene. Suitable phosphinates are described in WO-A 97/39053, the content of which in relation to phosphinates is incorporated into the present application. Especially preferred phosphinates in the context of the present invention are aluminium and zinc salts of dimethyl phosphinate, ethylmethyl phosphinate, diethyl phosphinate and methyl-n-propyl phosphinate and mixtures thereof.

m in formula (I) preferably stands for 2 and 3, particularly preferably for 3.
n in formula (II) preferably stands for 1 and 3, particularly preferably for 3.
x in formula (II) preferably stands for 1 and 2, particularly preferably for 2.

Very particularly preferably employed as component D) is aluminium tris(diethylphosphinate) [CAS No. 225789-38-8], which is supplied, for example, by Clariant International Ltd. Muttenz, Switzerland under the Exolit® OP1230 or Exolit® OP1240 trade name.

### Component E)

As components E) the compositions may contain at least one heat stabilizer selected from the group of sterically hindered phenols.

These are compounds having a phenolic structure and having at least one sterically demanding group on the phenolic ring. Preferred sterically hindered phenols are compounds having a molecular building block of formula (VI),

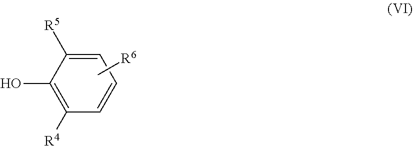

in which R⁴ and R⁵ stand for an alkyl group, for a substituted alkyl group or for a substituted triazole group, wherein the radicals R⁴ and R⁵ may be identical or different and R⁶ stands for an alkyl group, for a substituted alkyl group, for an alkoxy group or for a substituted amino group.

In organic chemistry steric hindrance describes the influence of the spatial extension of a molecule on the progress of a reaction. The term describes the fact that some reactions proceed only very slowly or not at all when large and bulky groups are present in the vicinity of the reacting atoms. A well known example of the influence of steric hindrance is the reaction of ketones in a Grignard reaction. When di-tert-butyl ketone is used in the Grignard reaction the very bulky tert-butyl groups retard the reaction so severely that at most a methyl group can be introduced while larger radicals no longer react at all.

Very particularly preferred heat stabilizers of formula (VI) are described as antioxidants for example in U.S. Pat. No. 4,360,617, the content of which is fully incorporated into the present application. A further group of preferred sterically hindered phenols is derived from substituted benzenecarboxylic acids, in particular from substituted benzenepropionic acids. Particularly preferred compounds from this class are compounds of formula (VII)

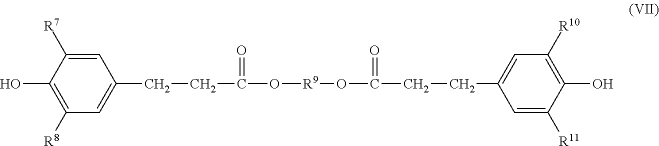

in which R⁷, R⁸, R¹⁰ and R¹¹ independently of one another represent C₁-C₈-alkyl groups which may themselves be substituted (at least one of these is a sterically demanding group) and R⁹ stands for a divalent alkyl radical having 1 to 10 carbon atoms which may also have CO bonds in the main chain. Preferred compounds of formula (VII) are compounds of formulas (VIII), (IX) and (X).

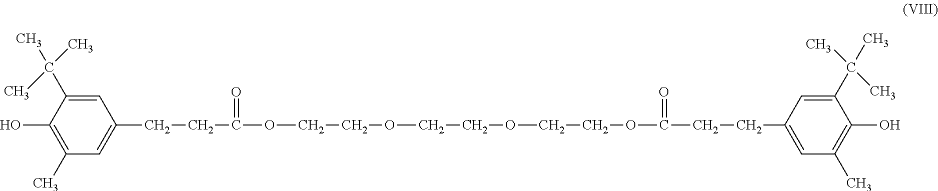 [SMILES: Cc1cc(CCC(=O)OCCOCCOCCOC(=O)CCc2cc(C)c(O)c(C(C)(C)C)c2)cc(C(C)(C)C)c1O]

Formula (VIII) is Irganox® 245 from BASF SE, [CAS No. 36443-68-2] which has the chemical name triethylene glycol bis(3-tert-butyl-4-hydroxy-5-methylphenyl)propionate.

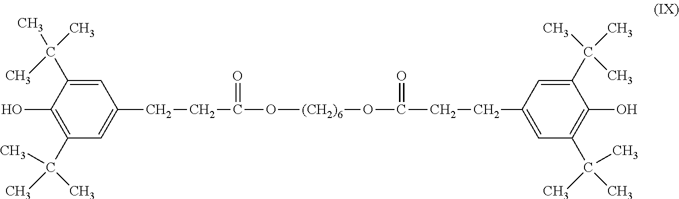

Formula (IX) is Irganox® 259 from BASF SE, [CAS No. 35074-77-2] which has the chemical name 1,6-hexamethylene bis(3,5-di-(tert)-butyl-4-hydroxyhydrocinnamate.

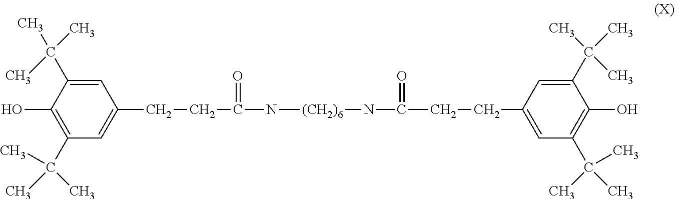

Formula (X) is Irganox® 1098 from BASF SE, [CAS No. 23128-74-7] which has the chemical name N,N′-hexamethylene bis[3-(3,5-di-t-butyl-4-hydroxyphenyl)propionamide].

Very particularly preferred heat stabilizers for use as component E) are selected from the group of 2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Heat stabilizers from the group of sterically hindered phenols especially preferred for use as component E) are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate] and N,N′-hexamethylenebis-3,5-di-tert-butyl-4-hydroxyhydrocinnamide (Irganox® 1098) and the abovementioned Irganox® 245 from BASF SE, Ludwigshafen, Germany.

A heat stabilizer from the group of sterically hindered phenols which is especially very particularly preferred according to the invention is N,N′-hexamethylene-bis-3,5-di-tert-butyl-4-hydroxyhydrocinnamide [CAS No. 23128-74-7] which is obtainable from BASF SE, Ludwigshafen, Germany as Irganox® 1098 or inter alia from Weihai Jinwei Chemlndustry Co., Ltd. as Lowinox® HD 98.

### Component F)

As components F) the compositions may contain glass fibres.

According to http://de.wikipedia.org/wiki/Faser-Kunststoff-Verbund, a distinction is made between chopped fibres, also called short fibres, having a length in the range from 0.1 to 1 mm, long fibres having a length in the range from 1 to 50 mm and continuous fibres having a length L>50 mm. Short fibres are employed in injection moulding and may be processed directly with an extruder. Long fibres can likewise still be processed in extruders. Said fibres are widely used in fibre spraying. Long fibres are often added to thermosets as a filler. Endless fibres are used in fibre-reinforced plastics in the form of rovings or fabric. Articles of manufacture comprising endless fibres achieve the highest stiffness and strength values. Also available are ground glass fibres whose length after grinding is typically in the range from 70 to 200 μm.

Preferably employed according to the invention as component F) are chopped long glass fibres having a starting length in the range from 1 to 50 mm, particularly preferably in the range from 1 to 10 mm, very particularly preferably in the range from 2 to 7 mm, wherein the starting length refers to the length immediately before incorporation/compounding into the moulding material and the fibre length of the chopped long glass fibres is determined by means of a USB microscope with calibration, in particular a Dino-Lite Edge AM7915MZT digital microscope with Dino Capture 2.0 software; Dino-Lite Europe/IDCP B.V., Naarden, the Netherlands.

Glass fibres preferred for use as component F) have a fibre diameter in the range of 7 to 18 μm, particularly preferably in the range from 9 to 15 μm, wherein the fibre diameter may be determined using a USB microscope with calibration, in particular a Dino-Lite Edge AM7915MZT digital microscope with Dino Capture 2.0 software; Dino-Lite Europe/IDCP B.V., Naarden, the Netherlands. In a preferred embodiment the glass fibres of component F) are modified with a suitable size system or an adhesion promoter/adhesion promoter system. It is preferable when a silane-based size system/adhesion promoter is employed. Alternative adhesion promoters may be found in EP 1 713 848 B1.

Particularly preferred silane-based adhesion promoters for the treatment of the glass fibres for use as component F) are silane compounds of general formula (XI)

(X—(CH₂)_{q})ₖ—Si—(O—CrH₂ᵣ₊₁)₄₋ₖ (XI)

in which
X stands for NH₂—, carboxyl-, HO— or

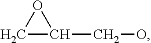

q in formula (XI) stands for an integer from 2 to 10, preferably 3 to 4,
r in formula (XI) stands for an integer from 1 to 5, preferably 1 to 2, and
k in formula (XI) stands for an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane and the corresponding silanes comprising as the substituent X a glycidyl group or a carboxyl group, wherein carboxyl groups are especially very particularly preferred.

For the modification of the glass fibres for use as component F), the adhesion promoter, preferably the silane compounds of formula (XI), are employed preferably in amounts of 0.05% to 2% by weight, particularly preferably in amounts of 0.25% to 1.5% by weight and very particularly preferably in amounts of 0.5% to 1% by weight in each case based on 100% by weight of component F).

As a consequence of the processing to afford the composition/to afford the article of manufacture the glass fibres of component F) may therein be shorter than the originally employed glass fibres. Thus the arithmetic average of the glass fibre length after processing is frequently only in the range from 150 μm to 300 μm.

According to “http://www.r-g.de/wiki/Glasfasern” glass fibres are produced in the melt spinning process (die drawing, rod drawing and die blowing processes). In the die drawing process, the hot mass of glass flows under gravity through hundreds of die bores in a platinum spinneret plate. The filaments can be drawn at a speed of 3-4 km/minute with unlimited length.

Those skilled in the art distinguish between different types of glass fibres, some of which are listed here by way of example:
E glass, the most commonly used material having an optimal cost-benefit ratio (E glass from R&G)
H glass, hollow glass fibres for reduced weight (R&G hollow glass fibre fabric 160 g/m² and 216 g/m²)
R, S glass, for elevated mechanical requirements (S2 glass from R&G)
D glass, borosilicate glass for elevated electrical requirements
C glass, having increased chemicals resistance
Quartz glass, having high thermal stability

Further examples may be found at “http://de.wikipedia.org/wiki/Glasfaser”. E glass fibres have gained the greatest importance for plastics reinforcing. E stands for electrical glass, since it was originally used in the electrical industry in particular. For the production of E glass, glass melts are produced from pure quartz with additions of limestone, kaolin and boric acid. As well as silicon dioxide, they contain different amounts of various metal oxides. The composition determines the properties of the products. Preferably employed according to the invention as component F) is at least one type of glass fibres from the group of E glass, H glass, R, S glass, D glass, C glass and quartz glass, particular preferably glass fibres made of E glass.

### Component G)

As component G) the compositions may contain at least one further filler or reinforcer distinct from the components B) and F).

Also employable are mixtures of two or more different fillers and/or reinforcers, preferably based on talc, mica, silicate, amorphous quartz glass, quartz flour, wollastonite, kaolin, amorphous silicas, nanoscale minerals, particularly preferably montmorillonites, magnesium carbonate, chalk, feldspar, barium sulfate or else untreated surface-modified or sized spherical fillers and reinforcers made of glass. However, in an alternative embodiment it is also possible to employ nanoboemite as component G) if required. It is preferable to employ mineral particulate fillers based on talc, mica, silicate, wollastonite, kaolin, amorphous silicas, magnesium carbonate, chalk, feldspar and/or barium sulfate. It is particularly preferable to employ mineral particulate fillers based on talc, wollastonite and/or kaolin.

Also employed with particular preference are acicular mineral fillers. According to the invention the term acicular mineral fillers is to be understood as meaning a mineral filler having a highly pronounced acicular character. Acicular wollastonites are preferred. It is preferable when the acicular mineral filler has a length:diameter ratio in the range from 2:1 to 35:1, particularly preferably in the range from 3:1 to 19:1, especially preferably in the range from 4:1 to 12:1. The average particle size of the acicular mineral fillers is preferably <20 μm, particularly preferably <15 μm, especially preferably <10 μm, determined with a CILAS GRANULOMETER.

However, particular preference is also given to non-fibrous and non-foamed ground glass having a particle size distribution having a d90 in the range from 5 to 250 μm, preferably in the range from 10 to 150 μm, particularly preferably in the range from 15 to 80 μm, very particularly preferably in the range from 16 to 25 μm. It is preferable to use non-fibrous and non-foamed ground glass additionally having a d10 in the range from 0.3 to 10 μm, preferably in the range from 0.5 to 6 μm, particularly preferably in the range from 0.7 to 3 μm. Particular preference is given to non-fibrous and non-foamed ground glass additionally having a d50 in the range from 3 to 50 μm, preferably in the range from 4 to 40 μm, particularly preferably in the range from 5 to 30 μm, wherein the particle size distribution is determined using an Ankersmid particle size analyzer which operates by the principle of laser obscuration (Eye Tech® including EyeTech® software and ACM-104 measuring cell, Ankersmid lab, Oosterhout, the Netherlands).

Having regard to the d10, d50 and d90 values, the determination thereof and the meaning thereof, reference is made to Chemie Ingenieur Technik (72) P. 273-276, 3/2000, Wiley-VCH Verlags GmbH, Weinheim, 2000, according to which the d10 is that particle size below which 10% of the amount of particles lie, the d50 is that particle size below which 50% of the amount of particles lie (median value) and the d90 is that particle size below which 90% of the amount of particles lie.

The specified particle size distributions/particle sizes in each case relate to particle sizes to be determined immediately before incorporation into the moulding material using the abovementioned Ankersmid particle size analyzer which operates according to the principle of laser obscuration (Eye Tech® including EyeTech® software and ACM-104 measuring cell, Ankersmid lab, Oosterhout, the Netherlands). It is preferable according to the invention when the non-fibrous and non-foamed ground glass has a particulate, non-cylindrical shape and has a length to thickness ratio of less than 5, preferably less than 3, more preferably less than 2. It will be appreciated that a value of zero is impossible.

The non-foamed and non-fibrous ground glass particularly preferred for use as component G) is additionally characterized in that it does not have the glass geometry typical of fibrous glass with a cylindrical or oval cross section having a length to diameter ratio (L/D ratio) greater than 5.

The non-foamed and non-fibrous ground glass particularly preferred for use as component G) according to the invention is preferably obtained by milling glass with a mill, preferably a ball mill and particularly preferably with subsequent sifting or sieving. Contemplated starting materials include all geometric forms of solidified glass.

Preferred starting materials for the milling to afford non-fibrous and non-foamed ground glass for use as component G) according to the invention also include glass wastes such as are generated as unwanted byproduct and/or as off-spec primary product in particular in the production of glass articles of manufacture. This includes in particular waste glass, recycled glass and broken glass such as may be generated in particular in the production of window or bottle glass and in the production of glass-containing fillers and reinforcers, in particular in the form of so-called melt cakes. The glass may be coloured, although preference is given to non-coloured glass as starting material.

Useful starting glasses for milling in principle include all glass types such as are described in DIN 1259-1 for example. Preference is given to soda-lime glass, float glass, quartz glass, lead crystal glass, borosilicate glass, A glass and E glass, particular preference being given to soda-lime glass, borosilicate glass, A glass and E glass, very particular preference to A glass and E glass, especially E glass. For the physical data and composition of E glass, reference may be made to “http://wiki.r-g.de/index.php?title=Glasfasern”. Non-fibrous and non-foamed ground E glass especially preferred for use according to the invention has at least one of the following features specified in table I:

TABLE I

| Properties of E glass | Unit | E glass |
|---|---|---|
| Density | g/cm² at 20° C. | 2.6 |
| Tensile strength | MPa | 3400 |
| Tensile elastic modulus | GPa | 73 |
| Elongation at break | % | 3.5-4 |
| Chemical composition | Unit | Value |
| SiO₂ | % | 53-55 |
| Al₂O₃ | % | 14-15 |
| B₂O₃ | % | 6-8 |
| CaO | % | 17-22 |
| MgO | % | <5 |
| K₂O, Na₂O | % | <1 |
| Other oxides | % | about 1 |

Likewise particularly preferred for the production of the non-foamed and non-fibrous glass for use as component G) are glass types in which the content of K₂O is less than or equal to 2% by weight based on all the components of the glass. The non-foamed and non-fibrous ground glass for use as component G) according to the invention is commercially available from VitroMinerals, Covington, Ga., USA for example. It is supplied as CS Glass Powder in the specifications CS-325, CS-500 and CS-600 or else as LA400. (see also “www.glassfillers.com” or Chris DeArmitt, Additives Feature, Mineral Fillers, COMPOUNDING WORLD, February 2011, pages 28-38 and “www.compoundingworld.com”).

The non-foamed and non-fibrous ground glass for use as component G) in a preferred embodiment preferably has a density (not bulk density!) according to ASTM C 693 in the range from 2400 to 2700 kg/m³, particularly preferably in the range from 2400 to 2600 kg/m³, and is therefore distinctly different from foamed glass (density=100-165 kg/m³), foamed glass pellets (density=130-170 kg/m³) and expanded glass (density=110-360 kg/m³); see also AGY product brochure Pub. No. LIT-2006-111R² (02/06).

It is preferable according to the invention when the non-foamed and non-fibrous ground glass for use as component G) has been provided with surface modification or sizing based on aminoalkyltrialkoxysilane. In alternative or preferred embodiments the non-foamed and non-fibrous ground glass may have been provided with additional silane- or siloxane-based surface modification or size, preferably with glycidyl-, carboxyl-, alkenyl-, acryloyloxyalkyl- and/or methacryloyloxyalkyl-functionalized trialkoxysilanes or aqueous hydrolysates thereof, and combinations thereof.

Preferred aminoalkyltrialkoxysilanes are aminopropyltrimethoxysilane, aminobutyltrimethoxysilane, aminopropyltriethoxysilane, aminobutyltriethoxysilane or aqueous hydrolysates thereof, very particular preference being given to aminopropyltriethoxysilane.

The aminoalkyltrialkoxysilanes are preferably used for surface coating in amounts of 0.01% by weight to 1.5% by weight, particularly preferably in amounts of 0.05% by weight to 1.0% by weight and very particularly preferably in amounts of 0.1% by weight to 0.5% by weight based on the non-foamed and non-fibrous ground glass.

The starting glass for the grinding may already have been given surface modification or sizing treatment. It is likewise possible for the non-foamed and non-fibrous ground glass for use as component G) in accordance with the invention to be given surface modification or sizing treatment after the grinding.

Employable in particular is MF7900 from Lanxess Deutschland GmbH, Cologne, a non-fibrous and non-foamed ground glass based on E glass having a d90 of 54 μm, a d50 of 14 μm, a d10 of 2.4 μm determinable by the abovementioned method of laser obscuration (particle size analyzer from Ankersmid) and having a median particle size of 21 μm in each case based on the particle surface area and containing about 0.1% by weight of triethoxy(3-aminopropyl)silane size.

The non-foamed and non-fibrous ground glass for use as component G) in accordance with the invention may as a result of the processing to afford the inventive composition or to afford articles of manufacture producible therefrom, and in the articles of manufacture themselves, have a smaller d90 or d50 or d10 and/or a smaller median particle size than the originally employed ground particles.

Apart from the non-foamed and non-fibrous ground glass, the other fillers and/or reinforcers mentioned as component G), in a preferred embodiment, have also been surface-modified, preferably with an adhesion promoter or adhesion promoter system, more preferably with an adhesion promoter system based on silane. However, pretreatment is not absolutely necessary.

Suitable adhesion promoters likewise include the silane compounds of the general formula (XI) already described hereinabove.

For the modification of component G) the silane compounds are generally used for surface coating in amounts of 0.05% to 2% by weight, preferably in amounts of 0.25% to 1.5% by weight and especially in amounts of 0.5% to 1% by weight based on the mineral filler of component G).

These further recited fillers of component G) may as a result of the processing to afford the composition or to afford the article of manufacture produced therefrom, or in the article of manufacture itself, also have a smaller d97 or d50 than the originally employed fillers.

### Component H)

Employed as component H) is at least one further additive distinct from the components B) to G).

Preferred additives for use as component H) are antioxidants and/or heat stabilizers, UV stabilizers, gamma ray stabilizers, hydrolysis stabilizers, antistats, emulsifiers, nucleating agents, plasticizers, processing aids, impact modifiers, dyes, pigments, laser absorbers, lubricants and/or demoulding agents and components for reducing water absorption distinct from the components B) to G) and further flame retardants, flow auxiliaries or elastomer modifiers distinct from the components C) and D). The additives for use as component H) may be used individually or in admixture or in the form of masterbatches.

Preferred heat stabilizers of component H) are phosphites, hydroquinones, aromatic secondary amines such as diphenylamines, substituted resorcinols, salicylates, benzotriazoles and benzophenones and also variously substituted representatives of these groups or mixtures thereof.

In an alternative embodiment, it is also possible to use, as component H)—if required—copper salts, especially copper(I) iodide, preferably in combination with potassium iodide, and/or sodium hypophosphite NaH₂PO₂.

UV stabilizers used are preferably substituted resorcinols, salicylates, benzotriazoles and benzophenones.

Colourants for use as component H) are preferably inorganic pigments, especially ultramarine blue, iron oxide, titanium dioxide, zinc sulfide or carbon black, and also organic pigments, in particular phthalocyanines, quinacridones, perylenes, and dyes, preferably nigrosin and anthraquinones.

Nucleating agents for use as component H) are preferably sodium phenylphosphinate or calcium phenylphosphinate, aluminium oxide or silicon dioxide, and very particularly preferably talc, this enumeration being non-exclusive.

Flow auxiliaries for use as component H) are preferably copolymers of at least one α-olefin with at least one methacrylic ester or acrylic ester of an aliphatic alcohol. Particularly preferred here are copolymers where the α-olefin is constructed from ethene and/or propene and the methacrylic ester or acrylic ester comprises as its alcohol component linear or branched alkyl groups having 6 to 20 C atoms. Very particular preference is given to 2-ethylhexyl acrylate [CAS No. 26984-27-0]. Features of the copolymers suitable as flow auxiliaries are not just their composition but also their low molecular weight. Accordingly, suitable copolymers for the compositions that are to be protected from thermal degradation in accordance with the invention are particularly those which have an MFI value measured at 190° C. and a load of 2.16 kg of at least 100 g/10 min, preferably of at least 150 g/10 min, more preferably of at least 300 g/10 min. The MFI, melt flow index, characterizes the flow of a melt of a thermoplastic and is subject to the standards ISO 1133 or ASTM D 1238.

Plasticizers preferred for use as component H) are dioctyl phthalate, dibenzyl phthalate, butyl benzyl phthalate, hydrocarbon oils or N-(n-butyl)benzenesulfonamide.

Elastomer modifiers for use as component H) preferably comprise inter alia one or more graft polymers of
H.1 5% to 95% by weight, preferably 30% to 90% by weight, of at least one vinyl monomer and
H.2 95 to 5 wt %, preferably 70 to 10 wt %, of one or more graft substrates having glass transition temperatures of <10° C., preferably <0° C., more preferably <−20° C.

The graft substrate H.2 generally has an average particle size (d50) of 0.05 to 10 μm, preferably 0.1 to 5 μm, particularly preferably 0.2 to 1 μm.

Monomers of H.1 are preferably mixtures of
H.1.1 50% to 99% by weight of vinylaromatics and/or ring-substituted vinylaromatics, in particular styrene, α-methylstyrene, p-methylstyrene, p-chlorostyrene, and/or (C₁-C₈)-alkyl methacrylates, in particular methyl methacrylate, ethyl methacrylate and
H.1.2 1% to 50% by weight of vinyl cyanides, in particular unsaturated nitriles such as acrylonitrile and methacrylonitrile, and/or (C₁-C₈)-alkyl (meth)acrylates, in particular methyl methacrylate, glycidyl methacrylate, n-butyl acrylate, t-butyl acrylate, and/or derivatives, in particular anhydrides and imides of unsaturated carboxylic acids, in particular maleic anhydride or N-phenylmaleimide.

Preferred monomers H.1.1 are selected from at least one of the monomers styrene, α-methylstyrene and methyl methacrylate; preferred monomers H.1.2 are selected from at least one of the monomers acrylonitrile, maleic anhydride, glycidyl methacrylate and methyl methacrylate.

Particularly preferred monomers are H.1.1 styrene and H.1.2 acrylonitrile.

Graft substrates H.2 suitable for the graft polymers for use in the elastomer modifiers are, for example, diene rubbers, EPDM rubbers, i.e. those based on ethylene/propylene and optionally diene, also acrylate, polyurethane, silicone, chloroprene and ethylene/vinyl acetate rubbers. EPDM stands for ethylene-propylene-diene rubber.

Preferred graft substrates H.2 are diene rubbers, especially based on butadiene, isoprene, etc., or mixtures of diene rubbers or copolymers of diene rubbers or mixtures thereof with further copolymerizable monomers, especially as per H.1.1 and H.1.2, with the proviso that the glass transition temperature of component H.2 is <10° C., preferably <0° C., more preferably <−10° C.

Particularly preferred graft substrates H.2 are ABS polymers (emulsion, bulk and suspension ABS), wherein ABS stands for acrylonitrile-butadiene-styrene, such as are described for example in U.S. Pat. No. 3,644,574 or in GB-A 1 409 275 or in Ullmann, Enzyklopadie der Technischen Chemie, vol. 19 (1980), p. 277-295. The gel content of the graft substrate H.2 is preferably at least 30 wt %, particularly preferably at least 40 wt % (measured in toluene).

The elastomer modifiers/graft polymers are produced by free-radical polymerization, preferably by emulsion, suspension, solution or bulk polymerization, in particular by emulsion or bulk polymerization.

Particularly suitable graft rubbers also include ABS polymers, which are produced by redox initiation with an initiator system composed of organic hydroperoxide and ascorbic acid according to U.S. Pat. No. 4,937,285.

Since, as is well known, the graft monomers are not necessarily entirely grafted onto the graft base in the grafting reaction, graft polymers are also understood in accordance with the invention to mean products which are produced via (co)polymerization of the graft monomers in the presence of the graft base and also obtained in the workup.

Likewise suitable acrylate rubbers are based on graft substrates H.2 which are preferably polymers of alkyl acrylates, optionally with up to 40% by weight, based on H.2, of other polymerizable, ethylenically unsaturated monomers. Preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, such as chloroethyl acrylate, glycidyl esters, and mixtures of these monomers. Graft polymers comprising butyl acrylate as the core and methyl methacrylates as the shell are especially preferred. Paraloid® EXL2300 from Dow Corning Corporation, Midland Mich., USA is particularly preferred.

Crosslinking may be achieved by copolymerizing monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes, but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02 to 5 wt %, in particular 0.05 to 2 wt %, based on the graft substrate H.2.

In the case of cyclic crosslinking monomers having at least 3 ethylenically unsaturated groups, it is advantageous to restrict the amount to below 1 wt % of the graft substrate H.2.

Preferred “other” polymerizable, ethylenically unsaturated monomers which, in addition to the acrylic esters, may optionally be used to produce the graft substrate H.2 are acrylonitrile, styrene, α-methylstyrene, acrylamides, vinyl C₁-C₆-alkyl ethers, methyl methacrylate, glycidyl methacrylate, butadiene. Preferred acrylate rubbers used as graft substrate H.2 are emulsion polymers having a gel content of at least 60 wt %.

Further preferably suitable graft substrates according to H.2 are silicone rubbers having graft-active sites, such as are described in U.S. Pat. Nos. 4,859,740, 4,861,831, 4,806,593 and 4,812,515.

As well as elastomer modifiers based on graft polymers, it is likewise possible to use elastomer modifiers which are not based on graft polymers and have glass transition temperatures of <10° C., preferably <0° C., particularly preferably <−20° C. These preferably include elastomers having a block copolymer structure and additionally thermoplastically meltable elastomers, in particular EPM, EPDM and/or SEBS rubbers (EPM=ethylene-propylene copolymer, EPDM=ethylene-propylene-diene rubber and SEBS=styrene-ethene-butene-styrene copolymer).

Preferred flame retardants for use as component H) are mineral flame retardants, nitrogen-containing flame retardants or phosphorus-containing flame retardants distinct from component C) or component D).

Preferred nitrogen-containing flame retardants are the reaction products of trichlorotriazine, piperazine and morpholine of CAS No. 1078142-02-5, in particular MCA PPM Triazine HF from MCA Technologies GmbH, Biel-Benken, Switzerland, melamine cyanurate and condensation products of melamine, for example melem, melam, melon or more highly condensed compounds of this type. Preferred inorganic nitrogen-containing compounds are ammonium salts.

It is further also possible to use salts of aliphatic or aromatic sulfonic acids or mineral flame retardant additives, in particular aluminium and/or magnesium hydroxide and also Ca—Mg carbonate hydrates (e.g. DE-A 4 236 122).

Also suitable are flame retardant synergists from the group of the oxygen-, nitrogen- or sulfur-containing metal compounds, particular preference being given to zinc-free compounds for the reasons mentioned above, especially molybdenum oxide, magnesium oxide, magnesium carbonate, calcium carbonate, calcium oxide, titanium nitride, boron nitride, magnesium nitride, calcium phosphate, calcium borate, magnesium borate or mixtures thereof.

In an alternative embodiment it is also possible—if required and having accounted for the above-described disadvantages—to use zinc compounds as component H). These preferably include zinc oxide, zinc borate, zinc stannate, zinc hydroxystannate, zinc sulfide and zinc nitride, or mixtures thereof.

In an alternative embodiment it is also possible—if required and having accounted for the associated disadvantages—to use halogen-containing flame retardants as component H).

Preferred halogen-containing flame retardants are commercially available organic halogen compounds, particularly preferably ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ethers, which can be used alone or in combination with synergists, especially antimony trioxide or antimony pentoxide.

Preferred phosphorus-containing flame retardants distinct from component C) or D) are red phosphorus, inorganic metal hypophosphites, especially aluminium hypophosphite, metal phosphonates, especially calcium phosphonate, derivatives of 9,10-dihydro-9-oxa-10-phosphaphenanthrene 10-oxides (DOPO derivatives), resorcinol bis(diphenyl phosphate) (RDP), including oligomers, and bisphenol A bis(diphenyl phosphate) (BDP) including oligomers, and also melamine pyrophosphate and, if required, melamine polyphosphate, and also melamine poly(aluminium phosphate), melamine poly(zinc phosphate) or phenoxyphosphazene oligomers and mixtures thereof.

Further flame retardants for use as component H) are char formers, particularly preferably phenol-formaldehyde resins, polycarbonates, polyimides, polysulfones, polyether sulfones or polyether ketones, and anti-dripping agents, especially tetrafluoroethylene polymers.

The flame retardants may be added in pure form or else via masterbatches or compactates.

Lubricants and/or demoulding agents for use as component H) are preferably long-chain fatty acids, especially stearic acid or behenic acid, salts thereof, especially calcium stearate or zinc stearate, and the ester derivatives or amide derivatives thereof, especially ethylenebisstearylamide, montan waxes and low molecular weight polyethylene or polypropylene waxes.

Montan waxes in the context of the present invention are mixtures of straight-chain saturated carboxylic acids having chain lengths of 28 to 32 carbon atoms.

In accordance with the invention particular preference is given to using lubricants and/or demoulding agents from the group of esters or amides of saturated or unsaturated aliphatic carboxylic acids having 8 to 40 carbon atoms with aliphatic saturated alcohols or amines having 2 to 40 carbon atoms and metal salts of saturated or unsaturated aliphatic carboxylic acids having 8 to 40 carbon atoms.

Very particular preference is given to using at least one lubricant and/or demoulding agent from the group of ethylenebisstearylamide, calcium stearate and ethylene glycol dimontanate.

The use of calcium stearate [CAS No. 1592-23-0] or ethylenebisstearylamide [CAS No. 110-30-5] is especially preferred.

The use of ethylenebisstearylamide (Loxiol® EBS from Emery Oleochemicals) is especially particularly preferred.

Preferred components for reducing water absorption for use as component H) are semiaromatic polyamides and/or polyalkylene terephthalates, polyalkylene terephthalates being very particularly preferred.

Among the semiaromatic polyamides it is in turn preferable to employ those produced from α,ω-diamines and the benzenedicarboxylic acids isophthalic acid and terephthalic acid, preferably isophthalic acid. Preferred aromatic structural units are selected from reactants of the group isophthalic acid, terephthalic acid, phenylenediamine, xylylenediamine. Preferred α,ω-diamines are 1,4-diaminobutane (hexabutylenediamine) or 1,6-diaminobutane (hexamethylenediamine). Semiaromatic polyamides very particularly preferred for use as components for reducing the water absorption are produced from isophthalic acid (PA61) [CAS No. 25668-34-2] or terephthalic acid (PA6T) [CAS No. 24938-70-3] and hexamethylenediamine [CAS No. 124-09-4]. Very particular preference is given to PA61 which is obtainable inter alia as Durethan® T40 from LANXESS Deutschland GmbH, Cologne.

The semiaromatic polyamides are preferably used in amounts in the range from 1 to 50 parts by mass, particularly preferably in amounts in the range from 3 to 40 parts by mass, very particularly preferably in amounts in the range from 8 to 25 parts by mass, in each case based on 100 parts by mass of component A).

Among the polyalkylene terephthalates it is particularly preferable to use polybutylene terephthalate and/or polyethylene terephthalate as components for reducing water absorption, polyethylene terephthalate being very particularly preferred. The polyalkylene terephthalates are preferably used in amounts in the range from 1 to 50 parts by mass, particularly preferably in amounts in the range from 3 to 40 parts by mass, very particularly preferably in amounts in the range from 8 to 25 parts by mass, in each case based on 100 parts by mass of component A). Polyethylene terephthalate for use according to the invention is commercially available for example as PET V004 (homopolymer; Invista, Gersthofen, Germany) or as PET Lighter® C93 (copolymer; Equipolymers, Milan, Italy).

Laser absorbers preferred for use as component H) are preferably selected from the group of antimony trioxide, tin oxide, tin orthophosphate, barium titanate, aluminium oxide, copper hydroxyphosphate, copper orthophosphate, potassium copper diphosphate, copper hydroxide, antimony tin oxide, bismuth trioxide and anthraquinone. Particular preference is given to antimony trioxide and antimony tin oxide. Very particular preference is given to antimony trioxide.

The laser absorber, in particular the antimony trioxide, may be used directly as a powder or in the form of masterbatches. Preferred masterbatches are those based on polyamide or those based on polybutylene terephthalate, polyethylene, polypropylene, polyethylene-polypropylene copolymer, maleic anhydride-grafted polyethylene and/or maleic anhydride-g rafted polypropylene, wherein the polymers for the antimony trioxide masterbatch may be used individually or in admixture. Very particular preference is given to using antimony trioxide in the form of a polyamide-6-based masterbatch.

The laser absorber can be used individually or as a mixture of two or more laser absorbers.

Laser absorbers are capable of absorbing laser light of a particular wavelength. In practice, this wavelength is in the range from 157 nm to 10.6 μm. Examples of lasers of these wavelengths are described in WO2009/003976 A1. Preference is given to using Nd:YAG lasers, which can achieve wavelengths of 1064, 532, 355 and 266 nm, and CO₂ lasers.

In a preferred embodiment the present invention relates to compositions/articles of manufacture, preferably battery system components, based on compositions containing
A) polyamide 6 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate),
   wherein length determination of the component B) is performed using a USB microscope with calibration.

In a preferred embodiment the present invention relates to compositions/articles of manufacture, preferably battery system components, based on compositions containing
A) polyamide 66 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate),
   wherein length determination of the component B) is performed using a USB microscope with calibration.

In a preferred embodiment the present invention relates to compositions/articles of manufacture, preferably battery system components, based on compositions containing
A) polyamide 6 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate) and
E) at least one heat stabilizer from the group of
   2,2′-methylenebis-(4-methyl-6-tert-butylphenol),
   1,6-hexanediol bis(3,5-di-tert-butyl-4-hydroxyphenyl]propionate, pentaerythrityl tetrakis[3-(3,5-di-tert-butyl-4-hydroxyphenyl)propionate],
   N,N′-hexamethylenebis-3,5-di-tert-butyl-4-hydroxyhydrocinnamide and
   triethylene glycol bis(3-tert-butyl-4-hydroxy-5-methylphenyl)propionate,
   wherein length determination of the component B) is performed using a USB microscope with calibration.

In a preferred embodiment the present invention relates to compositions/articles of manufacture, preferably battery system components, based on compositions containing
A) polyamide 66 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate) and
E) at least one heat stabilizer from the group of
   2,2′-methylenebis(4-methyl-6-tert-butylphenol),
   1,6-hexanediol bis(3,5-di-tert-butyl-4-hydroxyphenyl]propionate, pentaerythrityl tetrakis[3-(3,5-di-tert-butyl-4-hydroxyphenyl)propionate],
   N,N′-hexamethylenebis-3,5-di-tert-butyl-4-hydroxyhydrocinnamide and
   triethylene glycol bis(3-tert-butyl-4-hydroxy-5-methylphenyl)propionate,
   wherein length determination of the component B) is performed using a USB microscope with calibration.

In a preferred embodiment the present invention relates to compositions/articles of manufacture, preferably battery system components, based on compositions containing
A) polyamide 6 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate) and
E) N,N′-hexamethylenebis-3,5-di-tert-butyl-4-hydroxyhydrocinnamide,
   wherein length determination of the component B) is performed using a USB microscope with calibration.

In a preferred embodiment the present invention relates to compositions/articles of manufacture, preferably battery system components, based on compositions containing
A) polyamide 66 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate) and
E) N,N′-hexamethylenebis-3,5-di-tert-butyl-4-hydroxyhydrocinnamide,
   wherein length determination of the component B) is performed using a USB microscope with calibration.

In a preferred embodiment the present invention relates to compositions/articles of manufacture, preferably battery system components, based on compositions containing
A) polyamide 6 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate) and
H) at least one semiaromatic polyamide
   wherein length determination of the component B) is performed using a USB microscope with calibration.

In a preferred embodiment the present invention relates to compositions/articles of manufacture, preferably battery system components, based on compositions containing
A) polyamide 66 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate) and
H) at least one semiaromatic polyamide,
   wherein length determination of the component B) is performed using a USB microscope with calibration.

In a preferred embodiment the present invention relates to compositions/articles of manufacture, preferably battery system components, based on compositions containing
A) polyamide 6 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate) and
E) at least one heat stabilizer from the group of
   2,2′-methylenebis(4-methyl-6-tert-butylphenol),
   1,6-hexanediol bis(3,5-di-tert-butyl-4-hydroxyphenyl]propionate, pentaerythrityl tetrakis[3-(3,5-di-tert-butyl-4-hydroxyphenyl)propionate],
   N,N′-hexamethylenebis-3,5-di-tert-butyl-4-hydroxyhydrocinnamide and
   triethylene glycol bis(3-tert-butyl-4-hydroxy-5-methylphenyl)propionate and
H) at least one semiaromatic polyamide,
   wherein length determination of the component B) is performed using a USB microscope with calibration.

In a preferred embodiment the present invention relates to compositions/articles of manufacture, preferably battery system components, based on compositions containing
A) polyamide 66 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate) and
E) at least one heat stabilizer from the group of
   2,2′-methylenebis(4-methyl-6-tert-butylphenol),
   1,6-hexanediol bis(3,5-di-tert-butyl-4-hydroxyphenyl]propionate, pentaerythrityl tetrakis[3-(3,5-di-tert-butyl-4-hydroxyphenyl)propionate],
   N,N′-hexamethylenebis-3,5-di-tert-butyl-4-hydroxyhydrocinnamide and
   triethylene glycol bis(3-tert-butyl-4-hydroxy-5-methylphenyl)propionate and
H) at least one semiaromatic polyamide,
   wherein length determination of the component B) is performed using a USB microscope with calibration.

In a preferred embodiment the present invention relates to compositions/articles of manufacture, preferably battery system components, based on compositions containing
A) polyamide 6 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate) and
E) N,N′-hexamethylenebis-3,5-di-tert-butyl-4-hydroxyhydrocinnamide and
H) at least one semiaromatic polyamide,
   wherein length determination of the component B) is performed using a USB microscope with calibration.

In a preferred embodiment the present invention relates to compositions/articles of manufacture, preferably battery system components, based on compositions containing
A) polyamide 66 having a viscosity number determinable according to ISO 307 with a 0.5% by weight solution in 96% by weight sulfuric acid at 25° C. in the range from 80 to 180 ml/g,
B) carbon fibres, preferably having an average length in the range from 4 to 7 mm,
C) aluminium phosphonate of formula Al₂(HPO₃)₃.(H₂O)_{q} where q is in the range from 0 to 4,
D) aluminium tris(diethylphosphinate) and
E) N,N′-hexamethylenebis-3,5-di-tert-butyl-4-hydroxyhydrocinnamide and
H) at least one semiaromatic polyamide,
   wherein length determination of the component B) is performed using a USB microscope with calibration.

### Process

The present invention further relates to a process for producing PA6- and/or PA66-based compositions and articles of manufacture producible therefrom, preferably by injection moulding, which compared to compositions of the prior art have the feature that in UL94 testing according to method UL94V, in particular at wall thicknesses of 1.5 mm, a V-0 classification is achieved and/or that surface quality is impaired to a lesser extent after storage in a hot and humid climate, wherein said process comprises employing in combination with one another

carbon fibres, preferably having an average length in the range from 4 to 7 mm,
with
at least one aluminium salt of phosphonic acid and
with one or more organic phosphinic acid salts of formula (I) and/or one or more diphosphinic acid salts of formula (II) and/or polymers thereof,

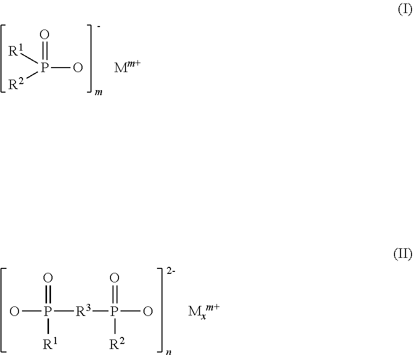

in which
R¹, R² are identical or different and stand for a linear or branched C₁-C₆-alkyl and/or for C₆-C₁₄-aryl,
R³ stands for linear or branched C1-Co-alkylene, C₆-C₁₀-arylene or for C₁-C₆-alkyl-C₆-C₁₀-arylene or C₆-C₁₀-aryl-C₁-C₆-alkylene,
M stands for aluminium, zinc or titanium,
m stands for an integer from 1 to 4;
n stands for an integer from 1 to 3 and
x stands for 1 and 2,
wherein n, x and m in formula (II) may at the same time adopt only integer values such that the diphosphinic acid salt of formula (II) as a whole is uncharged, wherein the respective polyamide has a viscosity number determinable according to ISO 307 in a 0.5% by weight solution in 96% by weight sulfuric acid at 25° C. in the range from 80 to 180 ml/g, wherein length determination of the carbon fibres is performed using a USB microscope with calibration.

The invention preferably relates to a process for producing PA6- and/or PA66-based compositions and articles of manufacture producible therefrom, preferably by injection moulding, which compared to compositions of the prior art have the feature that in UL94 testing according to method UL94V, in particular at wall thicknesses of 1.5 mm, a V-0 classification is achieved and/or that surface quality is impaired to a lesser extent after storage in a hot and humid climate, wherein said process comprises employing in combination with one another carbon fibres, preferably having an average length in the range from 4 to 7 mm, with a secondary aluminium phosphonate of formula Al₂(HPO₃)₃.(H₂O)_{q} where q is in the range from 0 to 4 produced according to example 2 of WO 2013/083247 A1, with aluminium tris(diethylphosphinate), wherein the respective polyamide has a viscosity number determinable according to ISO 307 in a 0.5% by weight solution in 96% by weight sulfuric acid at 25° C. in the range from 80 to 180 ml/g, wherein length determination of the carbon fibres is performed using a USB microscope with calibration.

The present invention also relates to a process for producing articles of manufacture, preferably articles of manufacture for use in the electric powertrain and/or battery system of vehicles with electric propulsion, in particular hybrid or electric vehicles, particularly preferably in the field of the battery system, especially preferably for structural components for holding, securing and mounting the battery system and/or individual components of the battery system, in particular cell modules, cooling apparatuses and/or battery management systems through use of the compositions according to the invention in injection moulding, including the specialized processes of GIT (gas injection technology), WIT (water injection technology) and PIT (projectile injection technology), in extrusion processes, including in profile extrusion or in blow moulding.

To produce these articles of manufacture the individual components of the inventive compositions are first mixed/compounded in at least one mixing apparatus and this mixture, which is then in the form of a moulding material, is either sent via at least one mixing apparatus outlet to direct further processing or is extruded and cut into pellets of the desired length by means of a pelletizer, preferably a rotating bladed roller, in order to be available for a later processing operation. The person skilled in the art understands compounding to mean the plastics-industry term, synonymous with plastics processing, which describes the finishing process for plastics by admixture of additive substances (fillers, additives etc.) for specific optimization of profiles of properties; see: https://de.wikipedia.org/wiki/Compoundierung. Compounding is preferably effected in extruders. Compounding comprises the process operations of conveying, melting, dispersing, mixing, degassing and pressurization.

Since most processors require plastic in the form of pellets, the pelletizing of the moulding compositions obtainable from the inventive compositions plays an essential role. A basic distinction is made between hot cutting and cold cutting. This results in different particle forms according to the processing. In the case of hot cutting, the pellets comprising the inventive compositions are obtained in beads or lenticular form; in the case of cold cutting, the pellets are obtained in cylinder forms or cube forms. Moulding compositions comprising inventive compositions in pellet form are preferably obtained by cold cutting.

The person skilled in the art is at liberty to use different mixing tools suitable for achieving an optimal mixing outcome in terms of mixing of the components in the moulding compositions obtainable from the inventive compositions. An extruder is a preferred mixing tool in the context of the present invention. Preferred extruders are single-screw extruders or twin-screw extruders and the respective sub-groups, most preferably conventional single-screw extruders, conveying single-screw extruders, contra-rotating twin-screw extruders, co-rotating twin-screw extruders, planetary gear extruders or co-kneaders.

These are familiar to those skilled in the art from Technische Thermoplaste 4. Polyamide, eds.: G. W. Becker and D. Braun, Carl Hanser Verlag, 1998, p. 311-314 and K. Brast, thesis entitled “Verarbeitung von Langfaser-verstärkten Thermoplasten im direkten Plastifizier-/Pressverfahren”, Rheinisch-Westfälische Technische Hochschule Aachen, 2001, p. 30-33.

The compositions present in the form of a moulding composition or pellets in accordance with the invention are ultimately used to produce the articles of manufacture according to the invention using moulding methods. Preferred moulding methods are injection moulding or extrusion.

Processes according to the invention for producing articles of manufacture by extrusion or injection moulding are preferably performed at melt temperatures in the range from 230° C. to 330° C., particularly preferably at melt temperatures in the range from 250° C. to 300° C., and preferably also at pressures of not more than 2500 bar, particularly preferably at pressures of not more than 2000 bar, very particularly preferably at pressures of not more than 1500 bar and especially preferably at pressures of not more than 750 bar.

### Use

The present application also provides for the use of the compositions according to the invention as moulding materials in injection moulding, including in the specialized processes of GIT (gas injection technology), WIT (water injection technology) and PIT (projectile injection technology), in extrusion processes, including in profile extrusion, in blow moulding, particularly preferably standard extrusion blow moulding processes, 3D extrusion blow moulding methods or suction blow moulding processes and also in 3-D printing in order to produce therefrom inventive articles of manufacture having a very high flexural modulus, high flame retardancy and low levels of surface changes under hot and humid ambient conditions.

The present invention also relates to the use of the compositions according to the invention for producing articles of manufacture, preferably articles of manufacture for use in the electric powertrain and/or battery system of vehicles with electric propulsion (hybrid or electric vehicles), particularly preferably in the field of a battery system, especially preferably for structural components for holding, securing and mounting a battery system and/or individual components of a battery system, preferably cell modules, cooling apparatuses and/or battery management systems.

The present invention also preferably provides for the use of the compositions according to the invention as moulding materials for overmoulding, surround-moulding, undermoulding or moulding-on of metals, functional elements and/or fibre-matrix semifinished products, the latter being preferred. Overmoulding, surround-moulding, undermoulding or moulding-on is effected by casting or injection moulding, preferably injection moulding. This may be effected in allover, partial or circulatory fashion. The injection moulding may be undermoulding and/or moulding-on and/or surround-moulding. This technique is known as in-mould forming (IMF), an integrative specialized injection moulding process used for producing hybrid structural components from different materials of construction; see http://www.industrieanzeiger.de/home/-/article/12503/11824771/. IMF makes it possible to include exposed reinforcing fibres in the edge region of a fibre-matrix semifinished product. This affords a structural component having particularly smooth edges. However, IMF also allows a functional element for moulding-on to be moulded and simultaneously joined to the fibre-matrix semifinished product component, in particular without the use of additional adhesives. The principle of IMF is also known from DE 4101106 A1, U.S. Pat. Nos. 6,036,908 B, 6,475,423 B1 or WO 2005/070647 A1.

Suitable matrix plastics for a fibre-matrix semifinished product for use in a manner preferred according to the invention in IMF are preferably the same plastics already used as the polymer for a moulding material according to the invention, i.e. PA 6 and/or PA 66.

Textile reinforcement of the fibre-matrix semifinished product to be subjected to overmoulding, surround-moulding, undermoulding or moulding-on employs textile semifinished products in which a multiplicity of individual filaments are suitably interconnected. Concerned here are in particular sheetlike textile semifinished products from the group of wovens, NCFs, multiaxial NCFs, stitched fabrics, braids, nonwovens, felts, mats and unidirectional fibre strands, preferably wovens or NCFs based on endless fibres and optionally also long fibres.

The endless fibres preferred for use for a textile semifinished product feature high mechanical performance at low weight. These are preferably technical fibres, in particular glass or carbon fibres, wherein carbon fibres are preferred according to the invention.

fibre-matrix semifinished products preferred for use according to the invention may also have been modified so as to be flame retardant, such as is described in EP 3 257 893 A1 for example.

Preferred functional elements made of the injection moulding component are fixings or holders and other applications which must be formed not by the fibre-matrix semifinished product component but, due to possible geometric complexity, by IMF by the injection moulding component.

To perform IMF a single-layer fibre-matrix semifinished product is placed in a mould, preferably an injection mould, having an appropriately shaped mould cavity. The injection moulding component is then injected. The aim here is to produce a cohesive join between the matrix polymer of the fibre-matrix semifinished product component and the polymer of the injection moulding component. Such a cohesive join is best achieved when each of the two polymers are based on the same polymer, for example PA 6 as the matrix polymer and PA 6 in the injection moulding component. The same applies to PA 66. It is preferable according to the invention when both components are based on the compositions according to the invention, wherein IMF also depends on process parameters such as melting temperature and pressure.

It will be understood that the specification and examples are illustrative but not limitative of the present invention and that other embodiments within the spirit and scope of the invention will suggest themselves to those skilled in the art.

### EXAMPLES

To demonstrate the improvements in properties described in accordance with the invention, corresponding polymer compositions were first made up by compounding. To this end the individual components in table II were mixed at temperatures in the range from 270° C. to 300° C. in a twin-screw extruder (ZSK 26 compounder from Coperion Werner & Pfleiderer (Stuttgart, Germany)), extruded, cooled until pelletizable and pelletized, wherein the carbon fibres were introduced at the rear (die-end) region of the extruder using a side extruder. After drying, generally for two days at 80° C. in a vacuum drying cabinet, the pellets were processed at temperatures in the range from 270 to 290° C. to give standard test specimens for the respective tests.

The flame retardancy of the test specimens having dimensions of 125 mm·13 mm·1.5 mm was determined according to the UL94V method (Underwriters Laboratories Inc. Standard of Safety, “Test for Flammability of Plastic Materials for Parts in Devices and Appliances”, pages 14-18 Northbrook 1998). Flexural modulus was obtained according to IS0178-A on test specimens having dimensions of 80 mm·10 mm·4 mm.

Assessment of surface changes was carried out by evaluating colour change with reference to black plates based on compositions according to table II and each having dimensions of 60 mm·40 mm·4 mm before and after 14 days of storage at 85° C. and 85% relative humidity according to the grey scale according to ISO105-A02. Storage was carried out in a constant climate cabinet of the KMF240 type from Binder (Tuttlingen, Germany) while evaluation of colour change was undertaken in a Macbeth Judge type II lighting booth from X-Rite (Grand Rapids, Mich., United States) using the “Day” setting. Evaluation was then carried out in stages according to the grey scale, wherein grey scale 5 means no colour change was observed and grey scale 1 means that a very high divergence from the original colour was observed. In order to ensure comparable evaluation all compositions according to the formulations in table II contained 0.3% carbon black (Blackpearls 800 from Cabot, Schaffhausen, Switzerland).

The experiments employed:
Component A/1: Polyamide 6 (Durethan® B24, LANXESS Deutschland GmbH, Cologne, Germany) having a viscosity number measured according to ISO 307 in a 0.5% by weight solution in 96% by weight sulfuric acid at 25° C. of 107 ml/g,
Component B/1: Chopped carbon fibres having an average cut length of 6 mm (Tenax®-J HT C493, Toho Tenax, Wuppertal, Germany), wherein the length was determined by means of a USB microscope with calibration (Dino-Lite Edge AM7915MZT digital microscope with Dino Capture 2.0 software; Dino-Lite Europe/IDCP B.V., Naarden, the Netherlands.
Component C/1: Secondary aluminium phosphonate, an aluminium phosphonate of formula Al₂(HPO₃)₃.(H₂O)_{q} where q is in the range from 0 to 4, produced according to example 2 of WO 2013/083247 A1,
Component D/1: Aluminium tris(diethylphosphinate), [CAS No. 225789-38-8] (Exolit® OP1230, Clariant SE, Muttenz, Switzerland),
Component E/1: Heat stabilizer Irganox® 1098, BASF, Ludwigshafen, Germany.
Component F/1: CS 7928 chopped glass fibre from LANXESS Deutschland GmbH, Cologne, Germany [average fibre diameter 11 μm, average fibre length 4.5 mm, E glass],
Component H/1: Ethylenebisstearylamide [CAS No. 110-30-5] obtained in the form of Loxiol® EBS from Emery Oleochemicals,
Component H/2: Carbon black in the form of Blackpearls 800 [CAS No. 1333-86-4] from Cabot, Schaffhausen, Switzerland,
Component H/3: Talc [CAS No. 14807-96-6] (Mistron R10, Imerys, Paris, France).

The comparative examples employed:
Component X1: Melamine polyphosphate (Melapur 200/70, BASF SE, Ludwigshafen, Germany),
Component X2: Zinc borate anhydrous [CAS No. 12767-90-7] (Firebrake 500, Borax Europe Limited, London, United Kingdom).

TABLE II

| Component | | Ex. 1 | Comp. 1 | Comp. 2 |
|---|---|---|---|---|
| A/1 | [parts by mass] | 100 | 100 | 100 |
| B/1 | [parts by mass] | 44.8 | | 44.8 |
| C/1 | [parts by mass] | 10.8 | | |
| D/1 | [parts by mass] | 21.5 | 25.4 | 25.4 |
| E/1 | [parts by mass] | 0.9 | 0.9 | 0.9 |
| F/1 | [parts by mass] | | 44.8 | |
| H/1 | [parts by mass] | 0.5 | 0.5 | 0.5 |
| H/2 | [parts by mass] | 0.5 | 0.5 | 0.5 |
| H/3 | [parts by mass] | 0.2 | 0.2 | 0.2 |
| X/1 | [parts by mass] | | 5.7 | 5.7 |
| X/2 | [parts by mass] | | 1.1 | 1.1 |
| Flexural modulus | [MPa] | >15000 | 9000 | — |
| UL94 @ 1.5 mm | class | V-0 | V-0 | V-1 |
| colour change after 14 d | ISO105-A02 | ≥4 | <4 | <4 |
| at 85° C./85% R.H. | | | | |

Reported quantities of the components in table II are in parts by mass based on 100 parts by mass of the component A1

The inventive example in table II shows that the inventive combination with component B/1 and C/1 resulted in a marked improvement in flexural modulus and surface quality after storage in a hot and humid climate without any reduction in flame retardancy determined according to UL94 despite the use of carbon fibres. This is surprising since in comp. 2 sole use of component B/1 without C/1 did not show an equivalent surface quality in terms of colour change after hot and humid storage and since in comp. 2 with a prior art flame retardant system containing only component D/1, X/1 and X/2 a V-0 classification could no longer be achieved when using component B/1 despite an identical overall concentration of flame retardant system, though this is possible when using glass fibres instead of carbon fibres (comp. 1).

What is claimed is:

1. A composition comprising:
A) a polyamide having a viscosity number of 80 to 180 nl/g determined according to ISO 307 with a 0.5% by weight solution in 96% by weight sulfuric acid at 25° C.,
B) fibre reinforcement,
C) at least one aluminium salt of phosphonic acid, and
D) one or more organic phosphinic acid salts of formula (I) and/or one or more diphosphinic acid salts of formula (II) and/or polymers thereof, 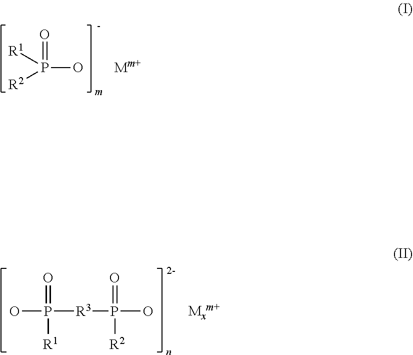
wherein
R¹, R² are identical or different and are linear or branched C₁-C₆-alkyl and/or for C₆-C₁₄-aryl,
R³ is linear or branched C₁-C₁₀-alkylene, C₆-C₁₀-arylene, C₁-C₆-alkyl-C₆-C₁₀-arylene, or C₆-C₁₀-aryl-C₁-C₆-alkylene,
M is aluminium, zinc or titanium,
m is an integer 1 to 4;
n is an integer 1 to 3, and
x is 1 or 2, and
n, x and m in formula (II) may at the same time adopt only integer values such that the diphosphinic acid salt of formula (II) as a whole is uncharged.

2. The composition according to claim 1, wherein:
the polyamide A) is at least one of polyamide 6 and polyamide 66; and
the fibre reinforcement B) comprises carbon fibres.

3. The composition according to claim 2, wherein:
the at least one aluminium salt of phosphonic acid C) comprises aluminium phosphonate of formula Al₂(HPO₃)₃.(H₂O)_{q} where q is 0 to 4, and
the one or more organic phosphinic acid salts of formula (I) and/or one or more diphosphinic acid salts of formula (II) and/or polymers thereof D) comprises aluminium tris(diethylphosphinate).

4. The composition according to claim 3, wherein the polyamide is polyamide 6.

5. The composition according to claim 3, wherein the polyamide is polyamide 66.

6. The composition according to claim 2, wherein the composition comprises, per 100 parts by mass of component A):
2 to 120 parts by mass of component B),
3 to 30 parts by mass of component C), and
8 to 80 parts by mass of component D).

7. The composition according to claim 1, further comprising at least one of:
E) at least one heat stabilizer selected from sterically hindered phenols;
F) glass fibres;
G) at least one filler or reinforcer distinct from the component B) and, if present, F); and
H) at least one further additive distinct from the components B) to D), and, if present E), F) and G).

8. The composition according to claim 1, further comprising:
E) at least one heat stabilizer selected from sterically hindered phenols;
F) glass fibres;
G) at least one filler or reinforcer distinct from the components B) and F); and
H) at least one further additive distinct from the components B) to G).

9. The composition according to claim 6, further comprising at least one of:
E) 0.02 to 4 parts by mass of at least one heat stabilizer selected from sterically hindered phenols;
F) 10 to 150 parts by mass of glass fibres;
G) 1 to 150 parts by mass of at least one filler or reinforcer distinct from the components B) and, if present, F); and
H) 0.01 to 80 parts by mass of at least one further additive distinct from the components B) to D), and, if present E), F) and G).

10. The composition according to claim 6, further comprising:
E) 0.02 to 4 parts by mass of at least one heat stabilizer selected from sterically hindered phenols;
F) 10 to 150 parts by mass of glass fibres;
G) 1 to 150 parts by mass of at least one filler or reinforcer distinct from the components B) and F); and
H) 0.01 to 80 parts by mass of at least one further additive distinct from the components B) to G).

11. The composition according to claim 6, wherein the composition comprises component E) and component E) is at least one heat stabilizer selected from the group consisting of 2,2′-methylenebis(4-methyl-6-tert-butylphenol), 1,6-hexanediol bis(3,5-di-tert-butyl-4-hydroxyphenyl]propionate, pentaerythrityl tetrakis[3-(3,5-di-tert-butyl-4-hydroxyphenyl)propionate], N,N′-hexamethylenebis-3,5-di-tert-butyl-4-hydroxyhydrocinnamide, and triethylene glycol bis(3-tert-butyl-4-hydroxy-5-methylphenyl)propionate.

12. The composition according to claim 11, wherein component E) is N,N′-hexamethylenebis-3,5-di-tert-butyl-4-hydroxyhydrocinnamide.

13. The composition according to claim 9, wherein the composition comprises to 1 to 50 parts by mass of component H), and component H) is a semiaromatic polyamide and/or a polyalkylene terephthalate.

14. The composition according to claim 10, wherein:
the carbon fibres B) have an average length of 4 to 7 mm and an average diameter of 5 to 10 μm;
the at least one aluminium salt of phosphonic acid C) comprises aluminium phosphonate of formula Al₂(HPO₃)₃.(H₂O)_{q} where q is 0 to 4;
the one or more organic phosphinic acid salts of formula (I) and/or one or more diphosphinic acid salts of formula (II) and/or polymers thereof D) comprises aluminium tris(diethylphosphinate);
the at least one heat stabilizer E) is selected from the group consisting of 2,2′-methylenebis(4-methyl-6-tert-butylphenol), 1,6-hexanediol bis(3,5-di-tert-butyl-4-hydroxyphenyl]propionate, pentaerythrityl tetrakis[3-(3,5-di-tert-butyl-4-hydroxyphenyl)propionate], N,N′-hexamethylenebis-3,5-di-tert-butyl-4-hydroxyhydrocinnamide, and triethylene glycol bis(3-tert-butyl-4-hydroxy-5-methylphenyl)propionate;
the glass fibres F) comprise chopped long glass fibres having a starting length of 2 to 7 mm;
the at least one filler or reinforcer G) comprises non-fibrous and non-foamed ground glass having a particle size distribution having a d90 of 16 to 25 μm, a dl 0 of 0.7 to 3 μm, and a d50 of 5 to 30 μm; and
the of at least one further additive H) is a semiaromatic polyamide and/or a polyalkylene terephthalate.

15. An article of manufacture comprising the composition according to claim 1.

16. The article of manufacture according to claim 15, wherein the article is a battery system component.

17. The article of manufacture according to claim 16, wherein the battery system component comprises a structural component for holding, securing and mounting a battery system and/or individual components of a battery system.

18. The article of manufacture according to claim 17, wherein the battery system component is a cell module, a cooling apparatus and/or a battery management system.

19. A process for producing an articles of manufacture, the process comprising injection molding, extruding, or blow molding the composition according to claim 1 to form a shaped article of manufacture.

20. The process according to claim 19, wherein:
the article of manufacture comprises an article for an electric powertrain and/or battery system for vehicles with electric propulsion; and
the injection moulding comprises gas injection, water injection, and projectile injection technology; and
the extruding comprises profile extrusion.
